(19) United States
(12) Patent Application Publication
(10) Pub. No.: US 2022/0358755 A1
(43) Pub. Date: Nov. 10, 2022

(54) SYSTEMS AND METHODS FOR HYPERSPECTRAL IMAGING AND ARTIFICIAL INTELLIGENCE ASSISTED AUTOMATED RECOGNITION OF DRUGS

(71) Applicant: Alfred E. Mann Institute for Biomedical Engineering at the University of Southern California, Los Angeles, CA (US)

(72) Inventors: Tejal GALA, Los Angeles, CA (US); Yanwen XIONG, Los Angeles, CA (US); Min Young Hur HUBBARD, Los Angeles, CA (US); John MAI, Los Angeles, CA (US)

(21) Appl. No.: 17/638,690

(22) PCT Filed: Aug. 28, 2020
(86) PCT No.: PCT/US2020/048589

§ 371 Date: Feb. 25, 2022

Related U.S. Application Data
(60) Provisional application No. 62/894,369, filed on Aug. 30, 2019.

(51) Int. Cl. G06V 10/82; G06V 10/776; G06V 10/77; G06V 10/26; G06V 10/764; G01N 21/27; G01N 21/25

(52) U.S. Cl. CPC G06V 10/82; G06V 10/776; G06V 10/7715; G06V 10/26; G06V 10/764; G01N 21/27; G01N 21/255; G01N 2021/1776

(57) ABSTRACT

This disclosure relates to a system and a method for automated recognition of drugs. This disclosure also relates to a system for automated recognition of drugs comprising a hyper-spectral imaging system. This disclosure also relates to a hyper-spectral imaging system configured to automatically recognize drugs by using a neural network. This disclosure relates to training the neural network to identify a drug type (e.g., the name of the drug) based on an image (e.g., normal visible image and/or hyperspectral image) of the drug.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application is a non-provisional of and claims benefit of U.S. Provisional Application No. 62/894,369, entitled “Systems and Methods for Hyperspectral Imaging and Artificial Intelligence Assisted Automated Recognition of Drugs,” filed on Aug. 30, 2019, attorney docket number AMISC.005PR. The entire content of this application is incorporated herein by reference.

### BACKGROUND

### Technical Field

This disclosure relates to a system and a method for automated recognition of drugs. This disclosure also relates to a system for automated recognition of drugs comprising a hyperspectral imaging system. This disclosure also relates to a hyperspectral imaging system configured to automatically recognize drugs by using an artificial intelligence algorithm.

### Description of Related Art

Former U.S. Surgeon General, C. Everett Coop is quoted as saying: “Drugs don't work in patients who don't take them.” Nationwide and individual hospital studies have shown that patients' non-adherence to their medication regime can cause certain economic and health care burdens. For example, Rosen et al. reported that the 30-day hospital readmission rates for patients with low or medium medication adherence was more than 2.5 times higher than for patients with high adherence [1] [all bracketed references are identified below]. In the U.S., non-adherence to a medication-based course of treatment could be responsible for up to 50% of treatment failures and up to 25% of all hospitalizations annually, which translates into approximately $100 billion to $300 billion in additional health care costs annually [2].

There are existing programs for identifying pills based on camera images. WebMD allows users to enter the shape, color, and/or imprint on the pill and will identify the pill based on those three characteristics [3]. The NIH has a program called Pillbox and Drugs.com offers a program called Pillbox Identification Wizard, both of which similarly require users to enter identifying information about the pill rather than a picture [4, 5]. In terms of existing smartphone applications, Drugs.com has the Drugs.com Medication Guide, which allows users to “look up drug information, identify pills, check interactions, and set up personal medication records” [6].

More than the number of mobile applications for identifying pills is the number of mobile applications for reminding people to take their medications. Among the pill reminder mobile applications are Round Health by Circadian Design, Mango Health by Mango Health, and Pill Reminder-all in One by Sergio Licea Sergio Licea [7, 8, 9]. These applications do not involve identifying pills using the phone camera. The iOS application Drug ID App Rene Castaneda does attempt to recognize pills based on an image database sourced from Cerner and using only the phone camera, but after taking the picture, the user is prompted to optionally enter the imprint, shape, and color of the pill [10].

### Related Art References

The following publications are related art for the background of this disclosure. One digit or two digit numbers in the box brackets before each reference, correspond to the numbers in the box brackets used in the other parts of this disclosure.

[1] O. Z. Rosen, et al. Medication adherence as a predictor of 30-day hospital readmissions. Patient preference and adherence 11, 801-810. (2017). doi: 10.2147/PPA.S125672.

[2] J. Kim, et al. “Medication Adherence: The elephant in the room,” US Pharm. 43(1)30-34. (2018).

[3] https://www/webmd.com/pill-identification.default.htm

[4] https://pillbox.nlm.nih.gov

[5] https://www.drugs.com/pill identification.html

[6] https://apps.apple.com/us/app/drugs-com-medication-guide/id599471042

[7] https://apps.apple.com/us/app/round-health/id1059591124

[8] https://www.mangohealth.com

[9] https://apps.apple.com/us/app/pill-reminder-all-inone/id816347839

[10] https://apps.apple.com/us/app/drug-id-app/ispb 1372681668

[11] F. Cutrale, V. Trivedi, L. A. Trinh, C. L. Chiu, J. M. Choi, M. S. Artiga, S. E. Fraser, “Hyperspectral phasor analysis enables multiplexed 5D in vivo imaging,” Nature Methods 14, 149-152 (2017).

[12] W. Shi, E. S. Koo, L. A. Trinh, S. E. Fraser, F. Cutrale, “Enhancing visualization of hyperspectral data with Phasor-Maps,” Molecular Biology of the Cell 28, (2017).

[13] http://bioimaging,usc.edu/software.html#HySP

[14] https://arxiv.org/pdf/1409.1556v6.pdf

[15] https://keras.io/applications/#vgg16

[16] https://www.pyimagesearch.com/2018/04/16/keras-and-convolutional-neural-networks-cnns/

[17] https://www.pdr.net/

### SUMMARY

Examples described herein relate to a system and a method for automated recognition of drugs. Examples described herein may also relate to a system for automated recognition of drugs comprising a hyperspectral imaging system. Examples described herein may also relate to a hyperspectral imaging system configured to automatically recognize drugs by using an artificial intelligence algorithm, such as a convolutional neural network (CNN).

In examples described in this disclosure, the drug may be any drug. For example, the drug may be an orally-ingested medicine. The drug may be a solid drug and/or a liquid drug.

In examples described in this disclosure, the accuracy of a proven CNN, VGG-16, in identifying various drug types from various standard camera images taken at different lighting, background, and angles can be compared with the hyperspectral images under similar variables. In another example, the wavelength information may be extracted from the deep learning algorithm VGG-16 and may be correlated with known characteristic chemical peaks of the drugs.

In examples described in this disclosure, the system for automated recognition of a drug may comprise a hyperspectral imaging system. The hyperspectral imaging system may be configured to automatically recognize a drug. The hyperspectral imaging system may be configured to automatically recognize a drug by using an artificial intelligence algorithm, such as a CNN. The artificial intelligence algorithm may comprise a machine learning algorithm.

In examples described in this disclosure, the hyperspectral imaging system may comprise a light source, a controller (processor), a detector (e.g., camera), and an information conveying system. The hyperspectral imaging system may comprise one or more polarizers and an information conveying system. The light source may comprise an array of at least one different light emitting diodes (LEDs) yielding more than three different spectral bands. The light source can contain an array of five light emitting diodes (LEDs) with six different spectral bands, which can result in a thirty-one band multispectral data. The light source may comprise an array of at least one light emitting diode (LED) with up to six different spectral bands. The light source may comprise an array of at least four light emitting diodes (LEDs) with up to six different spectral bands. The light source may comprise an array of six light emitting diodes (LEDs) with up to six different spectral bands. The light source may comprise an array of at least six light emitting diodes (LEDs) with up to thirty-one different spectral bands.

In examples described in this disclosure, the controller may be configured to run a phasor analysis software to analyze hyperspectral data. In examples described in this disclosure, the detector can comprise a camera.

In examples described in this disclosure, the information conveying system may comprise a display unit.

In examples described in this disclosure, the hyperspectral imaging system is further configured to recognize drugs by using a spectral band(s) that results in at least a 80% accuracy recognition accuracy for at least one spectral band.

In examples described in this disclosure, the hyperspectral imaging system is calibrated by using a calibration standard.

In examples described in this disclosure, the system for automated recognition of a drug may be incorporated into a user computing device, such as a mobile device. The mobile device may be any mobile device. For example, the mobile device may be a handheld device.

In examples described in this disclosure, the artificial intelligence algorithm (e.g., a CNN) may be configured to be trained and/or re-trained by incorporating a database into the system. The database may comprise information about commonly and/or uncommonly prescribed drugs.

In examples described in this disclosure, the artificial intelligence algorithm may comprise a convolutional neural network architecture.

In examples described in this disclosure, the CNN may be trained using transfer learning.

In examples described in this disclosure, the hyperspectral imaging system can be further configured to recognize the drug type by using one or more spectral bands that results in at least a 80% recognition accuracy for at least one spectral band.

In examples described in this disclosure, the drug type can include a name of the drug.

In examples described in this disclosure, the image of the drug is an image generated by using the hyperspectral imaging system.

In examples described in this disclosure, the hyperspectral imaging system can include a light source, a controller, a detector, an information conveying system, and at least one polarizer. The light source can comprise an array of at least 2 LEDs with more than 3 different spectral bands. The controller can be configured to run a phasor analysis software to analyze hyperspectral data.

In examples described in this disclosure, the detector can comprise a camera.

In examples described in this disclosure, the trained neural network can be trained by using transfer learning.

In examples described in this disclosure, the hyperspectral imaging system can be further configured to recognize the drug type by using one or more spectral bands that results in at least 80% recognition accuracy for at least one spectral band.

In examples described in this disclosure, the light source can include an array of 5 light emitting diodes.

In examples described in this disclosure, the light source can include an array of 5 LEDs with 6 spectral bands resulting in 31-band multispectral data.

In examples described in this disclosure, the hyperspectral imaging system can be calibrated by using a calibration standard. Examples described herein relate to a system for automated recognition of drugs. The system can comprises one or more hardware processors. The one or more hardware processors can be configured to process a plurality of images of the drug acquired from a hyperspectral imaging system and identify a drug type of the drug based on an application of a plurality of rules on the processed images.

In examples described in this disclosure, processing the acquired plurality of images can include cropping each of the images.

In examples described in this disclosure, processing the acquired plurality of images includes scaling down each of the images.

Examples described herein relate to a method for training a neural network, such as a CNN, to automatically recognize a drug type based on an image of a drug. The method can include: collecting a plurality of images of a plurality of drug types from a database; creating a training set of images comprising a first set of images of the plurality of images; creating a validating set of images comprising a second set of images of the plurality of images; applying one or more transformations to each of the images of the first set of images including cropping and/or scaling down to create a plurality of modified images; training the neural network using the plurality of modified images; and testing the trained neural network using the validating set of images.

In examples described in this disclosure, the plurality of images can comprise normal visible images of the plurality of drug types.

In examples described in this disclosure, the plurality of images can comprise about 400 images of each of the plurality of drug types.

In examples described in this disclosure, the plurality of images can comprise different images including different backgrounds, different orientations of the drug, and/or different lighting.

In examples described in this disclosure, the plurality of images can comprise hyperspectral images of the plurality of drug types.

In examples described in this disclosure, the plurality of images can comprise about six images of each of the plurality of drug types.

In examples described in this disclosure, further comprising, after collecting the plurality of images, injecting a Gaussian noise matrix into the plurality of images to increase a number of images.

In examples described in this disclosure, the plurality of images can comprise different images including different orientations of the drug and/or different lighting.

In examples described in this disclosure, the neural network can comprise a convolutional neural network.

Examples described herein relate to a method of using a drug identification system that can be configured to identity a drug type of a drug based on an image of the drug. The method can include: starting application on a user computing device; capturing an image of the drug with a detector; submitting the image of the drug into the application; and receiving a determined drug type, wherein the determine drug type is displayed on the user computing device.

In examples described in this disclosure, the user computing device can include a desktop computer, a laptop computer, or a smart phone.

These, as well as other components, steps, features, objects, benefits, and advantages, will now become clear from a review of the following detailed description of illustrative examples, the accompanying drawings, and the claims.

For purposes of summarizing the disclosure, certain aspects, advantages, and novel feature are discussed herein. It is to be understood that not necessarily all such aspects, advantages, or features will be embodied in any particular embodiment of the disclosure, and an artisan would recognize from the disclosure herein a myriad of combinations of such aspects, advantages, or features.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps. The colors disclosed in the following brief description of drawings and other parts of this disclosure refer to the color drawings and photos as originally filed with the U.S. provisional patent application 62/894,369, entitled “Systems and Methods for Hyperspectral Imaging and Artificial Intelligence Assisted Automated Recognition of Drugs,” filed Aug. 30, 2019, attorney docket number AMISC.005PR. The entire contents of these patent applications are incorporated herein by reference. The patent application file contains these and additional drawings and photos executed in color. Copies of this patent application file with color drawings and photos will be provided by the United States Patent and Trademark Office upon request and payment of the necessary fee.

FIG. 1 is a block diagram illustrating components of a low cost hyperspectral imager, according to certain aspect of the present disclosure.

FIG. 2A-2B are block diagrams illustrating a first stage and a second stage of a two-stage method that can be used to reconstruct a multispectral reflectance datacube from a series of camera images.

FIG. 3A is a flowchart illustrating an algorithm for training a convolutional neural network (CNN) for identifying normal visible images.

FIG. 3B is a flowchart illustrating an algorithm for running “transfer_train.py” and “transfer_classify.py” after training the CNN according to FIG. 3A.

FIGS. 3C-3F illustrate sample images of Bayer® aspirin, Tylenol® acetaminophen, Motrin® ibuprofen, and generic ibuprofen that can be used for training and testing of a CNN.

FIG. 4A illustrates the classification accuracy using a CNN algorithm called SmallerVGG.

FIG. 4B illustrates the classification accuracy using transfer learning with a CNN algorithm called VGG-16.

FIG. 5A is a flowchart illustrating an algorithm for training a CNN for identifying hyperspectral images.

FIG. 5B is a flowchart illustrating an algorithm for running a modified “transfer_train.py” and a modified “transfer_classify.py” after training the CNN according to FIG. 5A.

FIGS. 5C and 5E illustrate sample hyperspectral (false color) images of Motrin® and Tylenol®, respectively.

FIGS. 5D and 5F illustrate a Fourier-based phase analysis of each of the hyperspectral images, shown in FIGS. 5C and 5E, respectively.

FIG. 5G-5H show plots illustrating the effects of a pre-processing method on the relative results from a one dimensional CNN (1D CNN).

FIG. 6 is a flowchart illustrating the algorithm for training a CNN to identify normal visible and hyperspectral images.

FIG. 7A illustrates an example method of using a fully trained algorithm to identify a pill based on an image.

FIG. 7B illustrates a sample test image depicting ibuprofen that can be used to test a trained SmallerVGG.

FIG. 7C illustrates a sample test image depicting ibuprofen that can be used to test a trained VGG-16.

### DETAILED DESCRIPTION

Illustrative examples are now described. Other examples may be used in addition or instead. Details that may be apparent or unnecessary may be omitted to save space or for a more effective presentation. Some examples may be practiced with additional components or steps and/or without all of the components or steps that are described.

Following acronyms are used.

1D: One dimensional.
2D: Two dimensional.
3D: Three dimensional.
ASIC: Application specific integrated circuit
CMOS: Complementary metal-oxide semiconductor

### CNN: Convolutional Neural Network.

### HySP: Hyper-Spectral Phasors

### ILSVRC: ImageNet Large Scale Visual Recognition Challenge

LED: Light emitting diode
ReLU: Rectified linear unit

Examples described herein relate to a system and a method for automated recognition of drugs. Examples described herein may also relate to a system for automated recognition of drugs comprising a hyperspectral imaging system. Examples described herein may also relate to a hyperspectral imaging system configured to automatically recognize drugs by using an artificial intelligence algorithm.

This disclosure may relate to a development of a user-friendly smartphone application that may be used by patients and clinicians to track and verify adherence to a medical treatment regime requiring the routine ingestion of drugs. A hyperspectral imager can be built around a normal or standard camera, for example, a camera comprising a low-cost CMOS imager, which are currently commercially available through smartphones.

### Automated Recognition System

An automated recognition system can be configured to automatically recognize a drug by using an artificial intelligence algorithm based on an image of the drug. For example, a user can take a picture of their prescription with their smart phone and the automated recognition system can identify the type of drug. The automated recognition system can include a hyperspectral imaging system, however, traditional hyperspectral imaging system can be prohibitively costly because the traditional hyperspectral imaging system usually requires expensive specialized cameras (e.g., imaging spectrometers). A low-cost hyperspectral imaging system 50 that is adapted to acquire images and unmix spectral components is disclosed.

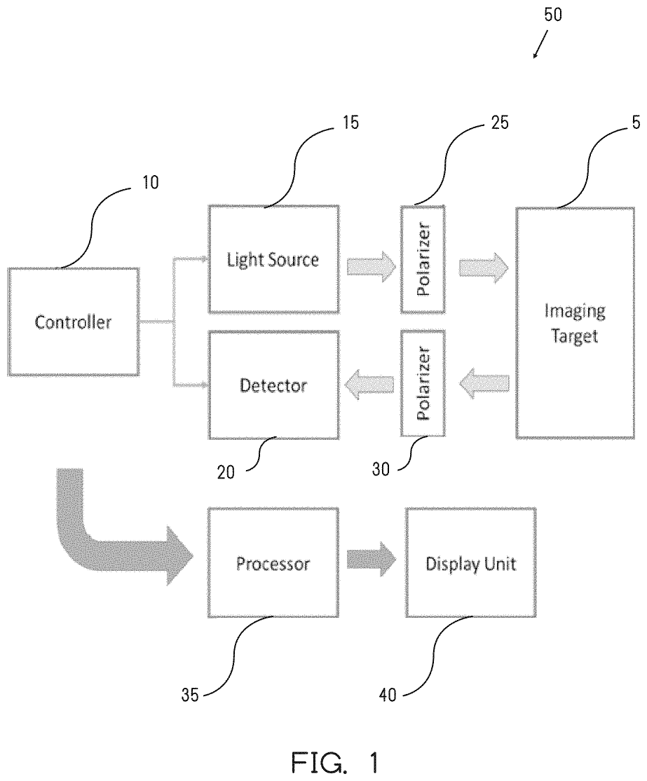

As shown in FIG. 1, the low-cost hyperspectral imaging system 50 can include a controller 10, at least one light source 15, at least one optical detector 20, one or more polarizers 25, 30, one or more processors 35, and/or a display unit 40. The light source 15 can include one or more LEDs. In some configurations, the light source 15 can comprise an array of at least one LED that yields up to six different spectral bands. In some configurations, the light source 15 can include an array of at least two LEDs, which includes at least one LED different from the other LED(s) and yields more than three different spectral bands. In some configuration, the light source 15 may comprise an array of at least four LEDs that yields up to six different spectral bands. In some configurations, the light source 15 can contain an array of five LEDs that yields six different spectral bands. In some configurations, the light source 15 may comprise an array of six LEDs that yields up to six different spectral bands. In some configurations, the light source 15 may comprise an array of at least six light LEDs that yields up to thirty-one different spectral bands.

The at least one optical detector 20 can be adapted to detect wavelengths from the imaging target 5. For example, the at least one optical detector 20 can include a low-cost, CMOS digital camera or a smartphone camera that can take 12 megapixel images with an f/1.8 aperture lens and can have built-in optical image stabilization. The CMOS digital camera can include a 35 mm lens and a CMOS imaging chip capable of taking up to 150 frames per second at 10-bit resolution. Each pixel on the CMOS imaging chip can be 5.86 microns, which yields a 2.35-megapixel image on a 1/1.2 inch size imaging chip.

Optionally, the system 50 can have one or more polarizers 25, 30 when used with visible wavelength imagers. The one or more polarizers 25, 30 can allow light waves of a certain polarization pass through while blocking light waves of other polarizations. For example, a first polarizer 25 of the one or more polarizers 25, 30 can filter light directed from the light source 15 to the imaging target 5 and a second polarizer 25 of the one or more polarizers 25, 30 can filter light reflected from the imaging target 5 and received by the detector 20.

The controller 10 can be any controller, for example, the controller 10 can be part of a user computing device, such as a desktop computer, a tablet computer, a laptop, and/or a smartphone. The controller 10 may control at least one component of the hyperspectral imaging system 50. The controller 10 can be adapted to control the at least one light source 15 and the at least one detector 20. For example, the controller 10 may control the at least one optical detector 20 to detect target radiation, detect the intensity and the wavelength of each target wave, transmit the detected intensity and wavelength of each target wave to the one or more processors 35, and display the unmixed color image of the imaging target 5 on the display unit 40. The controller 10 can be adapted to control an array of LEDs 15 such that the array of LEDs 15 sequentially illuminates an imaging target 5 (e.g., a pill). The controller 10 may control motions of the optical components, for example, opening and closure of optical shutters, motions of mirrors, and the like.

The one or more processors 35 can include microcontrollers, digital signal processors, application specific integrated circuit (ASIC), a field programmable gate array (FPGA) or other programmable logic device, discrete gate or transistor logic, discrete hardware components, or any combination thereof designed to perform the functions described herein. In some configurations, all of the processing discussed herein is performed by the one or more processor(s) 35. For example, the processor(s) 35 may form the target image, perform phasor analysis, perform the Fourier transform of the intensity spectrum, apply the denoising filter, form the phasor plane, map back the phasor point(s), assigns the arbitrary color(s), generate the unmixed color image of the target, the like, or a combination of such configurations thereof. The one or more processors 35 can also be a component of a user computing device.

The processor(s) 35 can be configured to run a phasor analysis software, which can be based on the HySP software originally developed and previously presented in [11] and [12]. The processor 35 can be configured to run the algorithm presented by Cutrale et al. in [11] and [12], and available for academic use as HySp [13]. For example, the Cutrale algorithm could be used to quickly analyze the hyperspectral data generated by the system 50 via the G-S phase plots of the Fourier coefficients of the normalized spectra, where:

$$z ( n ) = G ( n ) + i S ( n ) \qquad ( 1 )$$

$$G ( n ) = \frac{{\sum }_{λ s}^{λ f} I ( λ ) cos ( n ω λ ) Δ λ}{{\sum }_{λ s}^{λ f} I ( λ ) Δλ} \qquad ( 2 )$$

$$And$$

$$S ( n ) = \frac{{\sum }_{λ s}^{λ f} I ( λ ) sin ( n ω λ ) Δ λ}{{\sum }_{λ s}^{λ f} I ( λ ) Δλ} \qquad ( 3 )$$

Where λs and λf are the starting and ending wavelengths of bands of interest, respectively; I is the intensity; ω=2π/τs where τS is the number of spectral channels (e.g., 32) and n is the harmonic (e.g., n can be 1 or 2).

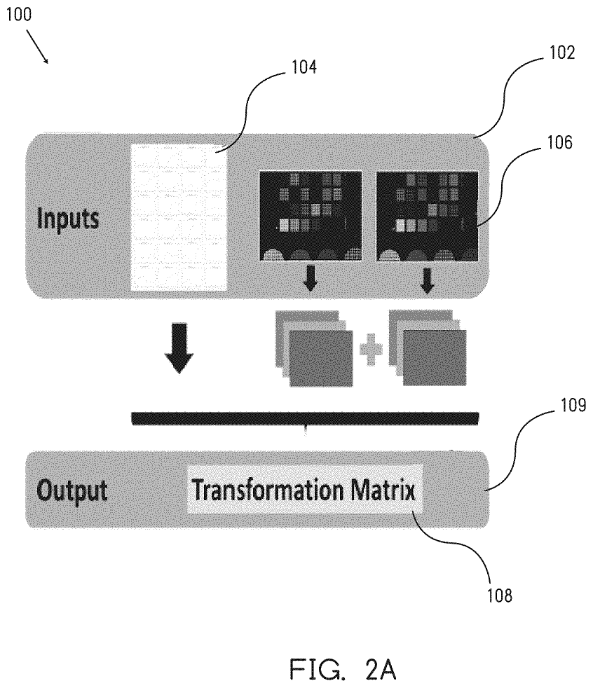

A multi-stage pseudo-inverse method, as illustrated in FIGS. 2A and 2B, can be used to reconstruct a hyperspectral cube from digital images. As shown in FIG. 2A, in Stage 1 100, certain inputs 102 (e.g., captured images 106 and/or known spectral reflectance factors 104) can be used to determine certain outputs 109 (e.g., a transformation matrix 108). For example, in Stage 1 100, the detector 20 can capture images 106 of a color standard under a sequence of different lighting conditions. In particular, a CMOS camera 20 can capture images 106 of the ColorChecker® standard (X-Rite Passport Model# MSCCP, USA). The known spectral reflectance factors 104 of the color standard can be used to solve for a transformation matrix 108. The transformation matrix 108 can be constructed by a generalized pseudo-inverse method based on singular value decomposition (SVD) where:

T=R×PINV(D) (4)

T=RD⁺(least-squares solution for RD−T) (5)

T=RD⁺=R(D^{T}D)⁻¹D^{T} (6)

Where T is the transformation matrix, the matrix R contains spectral reflectance factors of the calibration samples, PINV( ) is the pseudo inverse function, and the matrix D are the corresponding camera signals of the calibration samples.

As shown in FIG. 2B, in Stage 2 110, certain inputs 112 (e.g., captured images 114 and/or the transformation matrix 108) can be used to determine certain outputs 116 (e.g., a multi-spectral reflectance datacube 118). For example, in Stage 2 110, the transformation matrix 108 can be used to calculate the spectral information 118 of an imaging target 105 (e.g., a human hand) under the same lighting sequence as Stage 1 100. In particular, the predicted spectral reflectance factor R can be calculated using matrix multiplication and compared to the manufacturer provided color standard reflectance factors for validation, where:

R=T×D (7)

Where T is the transformation matrix, the matrix R contains spectral reflectance factors of the calibration samples, and the matrix D are the corresponding camera signals of the calibration samples. Advantageously, for this method, the camera spectral sensitivity does not need to be known prior.

### Neural Networks

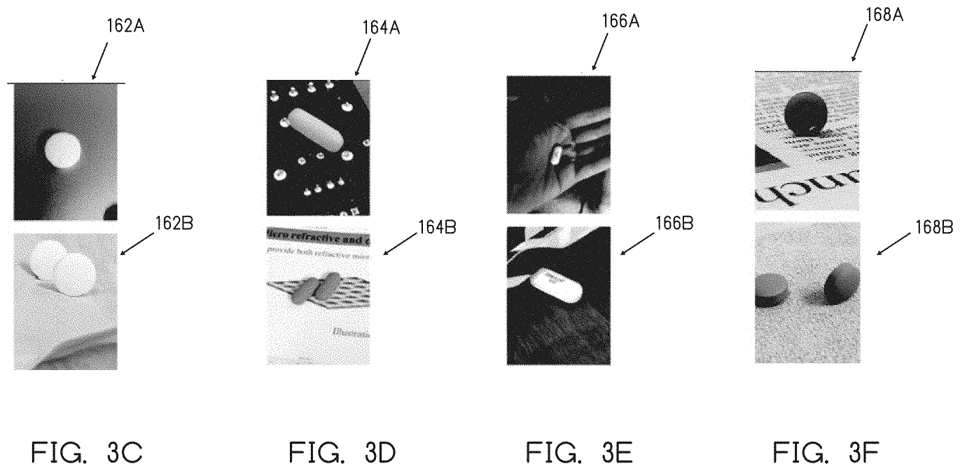

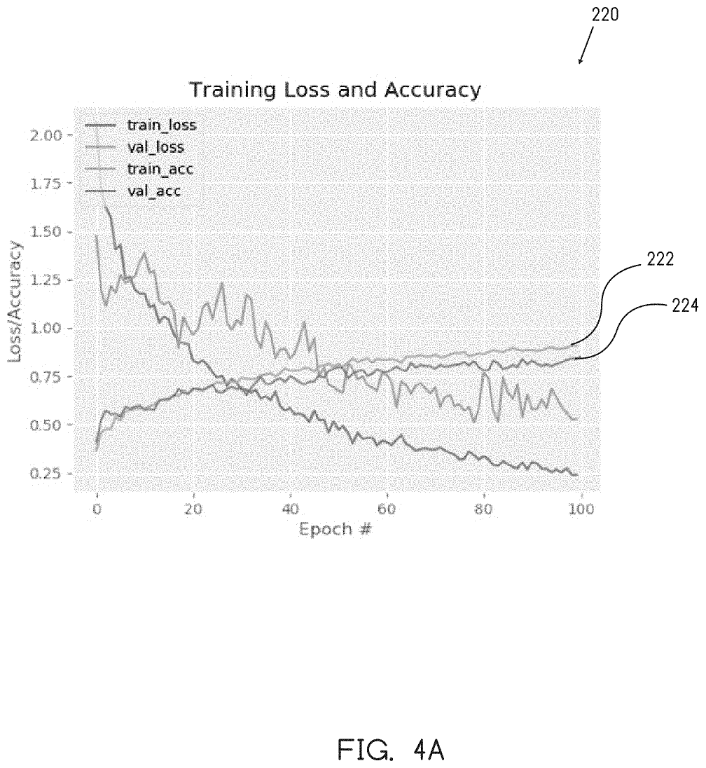

The processor(s) 35 can be configured to run a basic deep learning algorithm. For example, the algorithm can be VGG-16, which is a proven, highly accurate, image recognition algorithm based on a CNN architecture and previously verified on ILSVRC classification and localization tasks [14, 15]. Training VGG-16 on the one or more processor(s) 35 can require a lengthy amount of time. Therefore, transfer learning can be used to increase the efficiency of the VGG-16 code and run the CNN (i.e., VGG-16) on the one or more processor(s) 35 (e.g., a desktop computer with 16GB of RAM available) in a reasonable amount of time. For example, transfer learning with VGG-16 can reduce the required processing power to train VGG-16 such that VGG-16 with transfer learning can take less than one minute to process the image training data while other algorithms (e.g., Smallervggnet.py) can take approximately 90 minutes to train. Also, transfer learning can improve the prediction results of VGG-16, as shown in FIG. 4B as described in more detail herein.

It may be difficult to run the VGG-16 code in the context of a mobile application because some machine learning frameworks, such as CoreML, can have certain restrictions on transfer learning. Therefore, the one or more processors 35 can be configured to run the smallervggnet.py code, also referred to as SmallerVGG, which can be implemented in a mobile application. The smallervggnet.py use-case is outlined in [16]. The architecture of smallervggnet.py resembles that of VGG-16 but it can have fewer layers. VGG-16 can have a maximum of thirteen convolutional layers and three dense layers while smallervggnet.py can have five convolutional layers and two dense layers. Smallervggnet.py can contain a 2D CNN, which requires input images to have three dimensions.

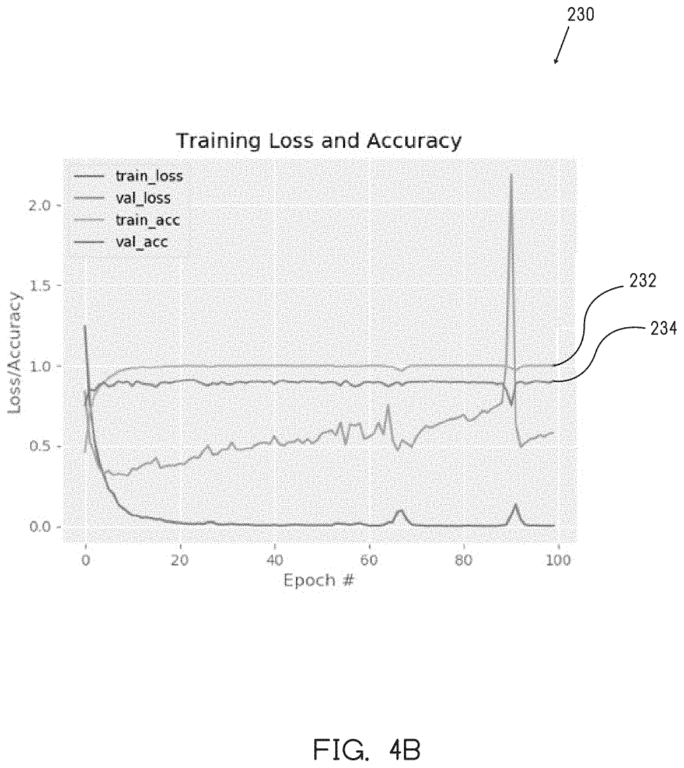

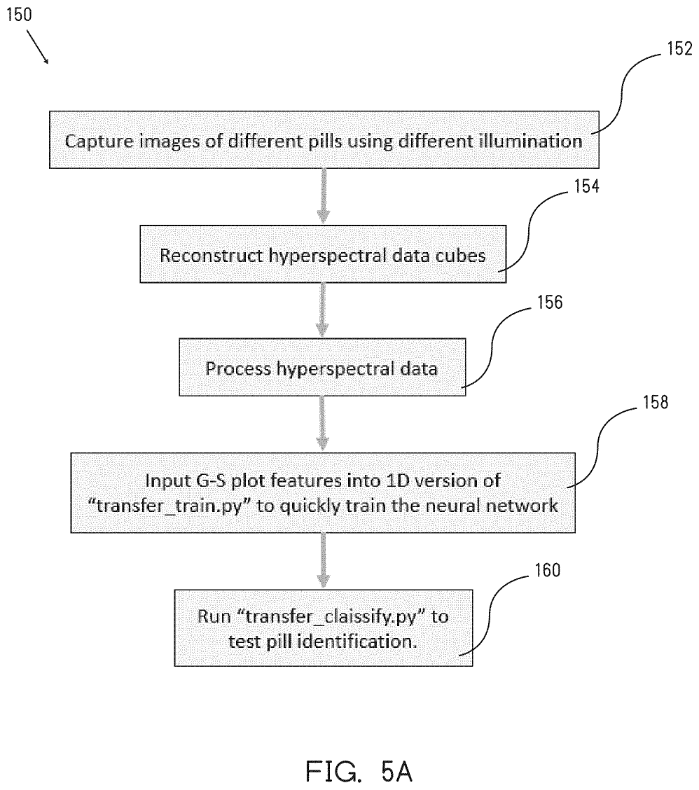

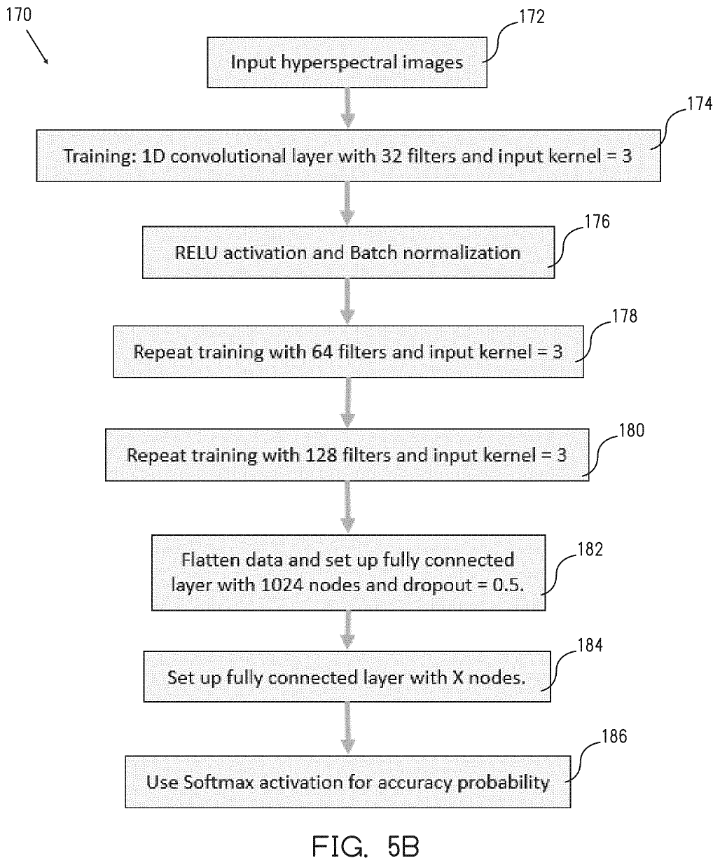

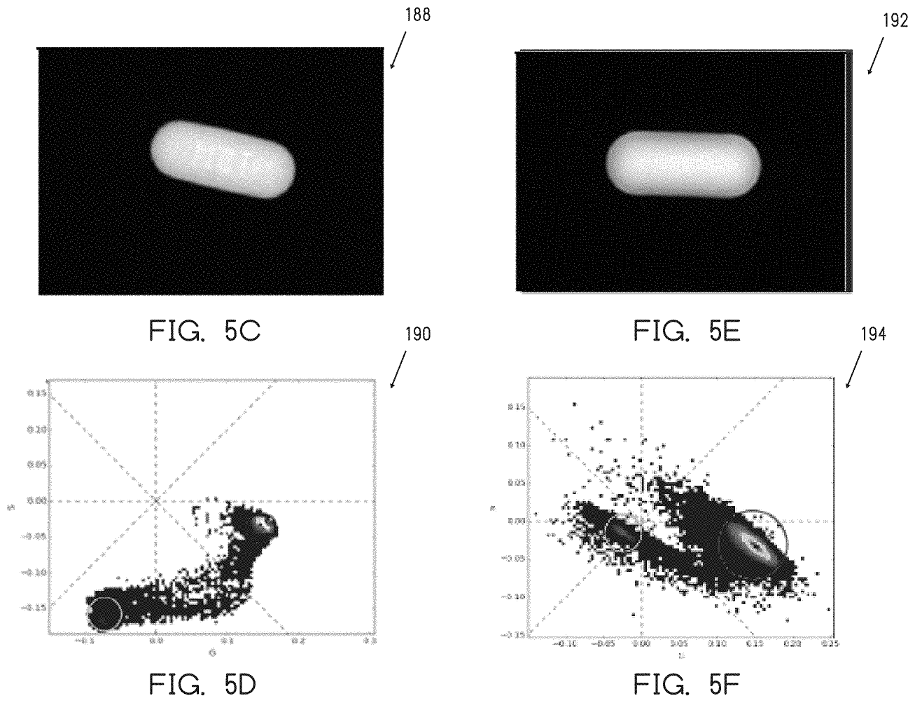

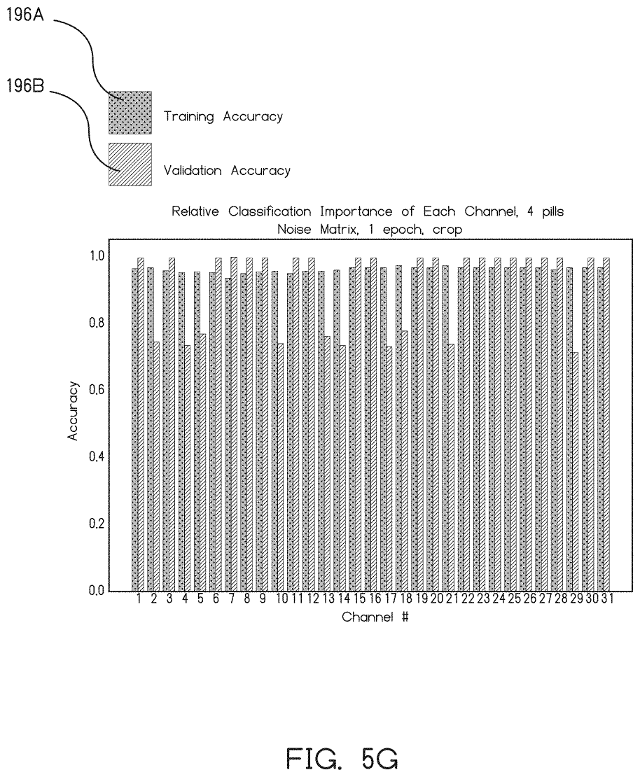

The processor(s) 35 can also be trained with a custom program adapted from VGG-16 called Hyperspec.py. Hyperspec.py can contain a 1D CNN, which requires the inputs to have two dimensions. Hyperspec.py can be trained on HySP output only or HySP output in conjunction with, for example, a complete 31 waveband hyperspectral hypercube, as discussed with reference to FIGS. 5G-5H as described in more detail herein. For example, a database that includes the top 200 most common pills could cover more than a billion drug prescriptions in the U.S. alone. Hyperspec.py based on HySP output could reduce the training time required while possibly maintaining the high accuracy rate achieved with the limited hyperspectral data disclosed in FIGS. 5G-5H.

Methods to train neural networks to recognize pill using normal visible images

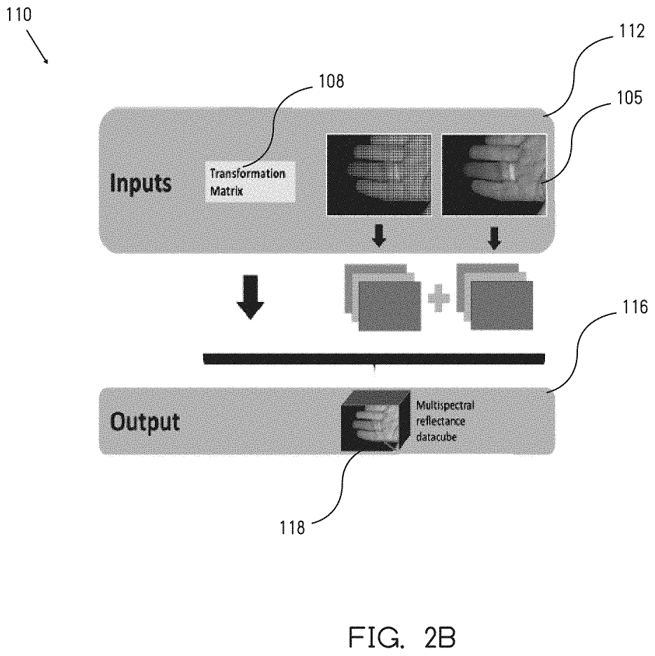

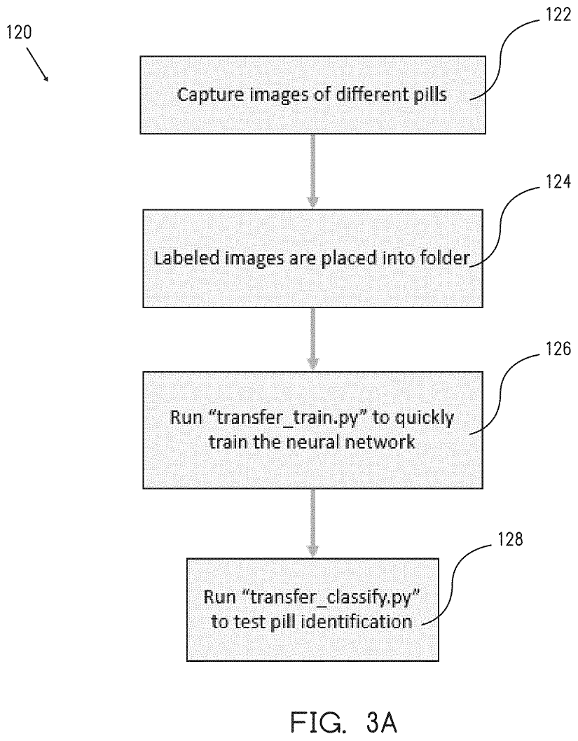

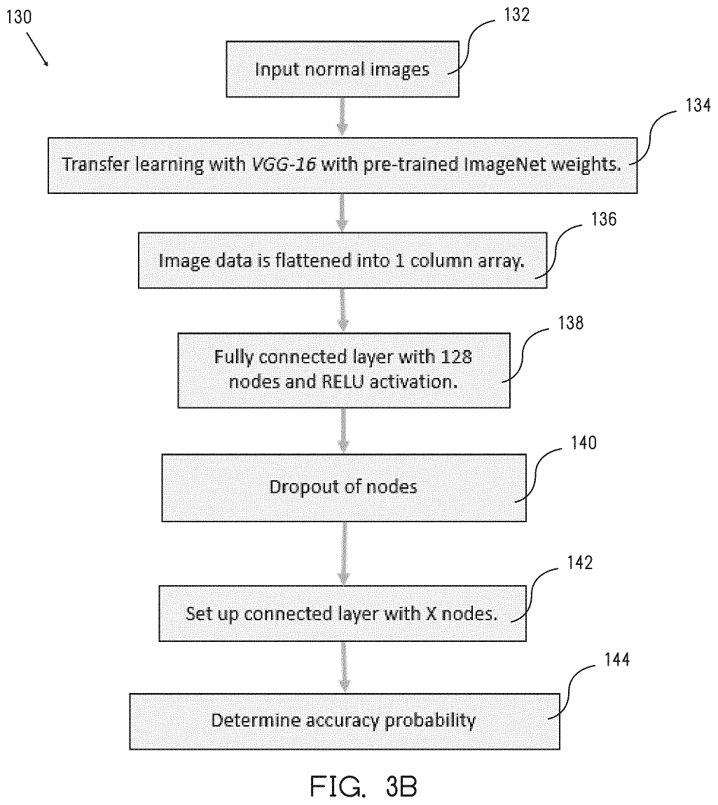

Both the smallervggnet.py and VGG-16 can be trained with a pill dataset including pill images from a normal camera such that the trained CNNs can determine a drug type based on a normal visible image of the pill. For example, FIG. 3A is a flowchart that illustrates an example algorithm 120 for training a CNN to recognize normal visible images of different pills. At block 122, different images can be captured of different pills with variable backgrounds, pill orientation, lighting, shadows, and the like. Advantageously, the variable backgrounds can make the training more realistic such that, in use, the background of the pill image does not matter. For example, FIGS. 3C-3F illustrate sample images of common over-the-counter headache and inflammation reducing medicines: Bayer® 350 mg aspirin (acetylsalicylic acid, NDC 0280-2000-10) 162a, 162b, Tylenol® 500 mg (acetaminophen, NDC 50580-449-10) 242, Motrin® 200 mg (ibuprofen, NDC 50580-230-09) 164a, 164b and, generic ibuprofen 200 mg (PhysiciansCare Model #90015) 168a, 168b, respectively. Images of these four medicines can be used to test and train VGG-16 and SmallerVGG. For example, approximately 500 images of each pill type can be taken under various lighting conditions, angles, distances from the camera (e.g., in and out of focus), and backgrounds. Approximately 400 images of each pill type can used to train the CNNs and approximately 100 images of each pill type can be used for testing. The cameras of the same and/or different smartphones can be used to capture the images. At block 124, the images are labeled and placed into a folder (e.g., a “PhoneCam” folder). At block 126, the “transfer_train.py” code can be run to quickly train the CNN. At block 128, the “transfer_classify.py” can be run to test pill identification capabilities of the trained CNNs.

FIG. 3B illustrates an example method 130 for training a CNN using the “transfer_train.py” code and testing the trained CNN using the “transfer_classify.py” code. For example, a pre-built and pre-trained (e.g., trained on a larger generic image dataset) VGG-16 can be trained on a pill dataset in an effort to transfer its knowledge to a smaller dataset (i.e., transfer learning). At block 132, a plurality of normal images (i.e., a pill dataset) can be input into the CNN (e.g., VGG-16). For example, the pill dataset can include approximately 1,834 pill images, which can include 46 pill images scanned from the internet and 1,788 pill images taken using a camera (e.g., a smartphone camera). Additionally, or alternatively, the pill dataset can include the images capture at block 122 of the method 120 shown in FIG. 3A.

Additionally or alternatively, at block 134, the normal images can be processed prior to inputting the images in VGG-16. For example, the pill images can be resized from their original resolution down to a 96 pixel×96 pixel×3 data cube (e.g., each image can be scaled down to a [96, 96, 3] matrix), where 3 is the RGB component of the image, to ensure that all of the input matrices into the CNN are the same size. If the pill dataset was used to train VGG-16, it could exceed a computer's memory capacity. Therefore, resizing the images to a smaller size can allow VGG-16 to be trained without exceeding the computer's memory capacity. The training set of different pill types can easily be expanded by the methods disclosed herein and using the Prescriber's Digital Reference®, which contains information about the specific colored dyes, pill shapes, and markings for all FDA-approved drugs in the United States [17].

At block 134, transfer learning can be performed with VGG-16 with pre-trained ImageNET weights. As previously discussed, transfer learning can increase the efficiency and improve the prediction results of the CNN. At block 136, the images can be further processed and flattened into a column array. At block 138, a fully connected VGG-16 can be trained with ReLU activation. For example, VGG-16 can have 128 nodes and all 128 can be trained at block 138. At block 140, a certain number of nodes can be dropped out. For example, half the number of nodes (e.g., 64 nodes) can be randomly dropped out. Additionally, or alternatively, the pre-built and pre-trained VGG-16 can be trained by freezing early CNN layers and only training the last few layers, which can be used to make a prediction about the type of pill. For example, the last seven CNN layers of VGG-16 can be trained with transfer learning. From the early frozen CNN layers, VGG-16 can extract general features applicable to all images (e.g., edges, shapes, and gradients). From the later unfrozen CNN layers, VGG-16 can identify specific features, such as markings and colors.

At block 142, a connected layer with “X” nodes can be set up. “X” can refer to the total number of different pills to identify. For example, if only images of the pills shown in FIGS. 3C-3F are used, then X would be 4. At block 144, the accuracy probability can be determined. For example, Sofmax activation can be used and/or the accuracy probability can be determined after at least 80 epochs. The accuracy probability of a CNN trained using only normal visible images of different drugs can be about 90%. Smallervggnet.py can be trained using similar steps as shown in FIG. 3B, with inapplicable steps removed.

In some situations, transfer learning with VGG-16 can produce more accurate results than smallervggnet.py. Referring to FIG. 4A, after 100 epochs, the plot 220 illustrates the training accuracy 222 of a trained SmallerVGG can be approximately 90% when classifying the approximately 2,000 images in the training set into the four different pill types. When tested against the remaining approximately 400 pill images, the validation accuracy 224 of the trained smallervggnet.py can drop to 85%. As shown in FIG. 4B, after transfer learning is applied to VGG-16, the plot 230 illustrates the training accuracy 232 of VGG-16 can increase to 100% while the validation accuracy 234 of VGG-16 can increase to above 90%.

### Methods to Train Neural Networks to Recognize Pill Using Hyperspectral Images

Hyperspec.py can be trained with hyperspectral images of different drugs such that the trained CNN can determine a drug type based on a hyperspectral image of the drug. FIG. 5A is a flowchart illustrating an example algorithm 150 for training the CNN, such as Hyperspec.py, to recognize hyperspectral images of different pill types. At block 152, different images of different pills can be captured. The different images can vary based on pill orientation, lighting, and the like. For hyperspectral imaging, the background of the pill image does not matter unlike normal visible images. Therefore, fewer images can be used to train the CNN to recognize hyperspectral images compared to normal visible images. For example, six images of each pill can be taken with three different pill orientation and two different LED illuminations. In comparison, hundreds to thousands of pill images with varying backgrounds, lighting, pill orientation, and the like can be used to train the CNN with normal visible images. Advantageously, training with fewer images reduces the amount of time and processing power needed to train the CNN.

Sample hyperspectral images of Motrin® 188 and Tylenol® 192 are presented in FIGS. 5C and 5E, respectively. The hyperspectral system 50 that produced these images can include a camera with a 35 mm lens (i.e., a detector 20) capable of taking up to 150 frames per second at 10-bit resolution. The camera 20 can be synchronized with a custom five LED illuminator (i.e., a light source 15), which can be used with phasor analysis (e.g., HySp software) to extract 31 wavelength bands. The five LED illuminator 15 can include LED illumination peaks at 447 nm, 530 nm, 627 nm, 590 nm, and a white light LED at a color temperature of 6500K.

At block 154, hyperspectral data cubes can be reconstructed using, for example, a pseudo-inverse method. At block 156, the hyperspectral data can be processed. For example, a HySp algorithm can be used to obtain data plots for a G-S plot from a Fourier-based phase analysis (e.g., pseudo-inverse method). FIGS. 5D and 5F illustrate the phasor representation 190, 194 of Motrin® 188 and Tylenol® 192 (e.g., a G-S plot from a Fourier-based phase analysis) shown in FIGS. 5C and 5E, respectively. As shown in FIGS. 5C and 5E, the hyperspectral images 188, 192 for each pill can look similar, irrespective of the pill orientation, background, or illumination. Thus, a Gaussian noise matrix can be injected in order to grow the data set of noisy RGB images of each pill type. The Python function “numpy.random.normal” can be used to generate the noisy array of pill images.

At block 158, the G-S data points can be input into a 1D version of the “transfer_train.py” code. The “transfer_train.py” code can be used to quickly train the CNN (e.g., Hyperspec.py). At block 160, the “transfer_classify.py” code can be run to test the trained CNN's ability to determine a pill's type based on the hyperspectral image.

FIG. 5B illustrates a flowchart of an example method 170 for training a CNN using a modified “transfer_train.py” code and a modified “transfer_classify.py” code with pre-processed hyperspectral data. At block 172, a plurality of hyperspectral images can be input into the CNN (e.g., Hyperspec.py). The images can originally have a resolution of (600,960) pixels. The images can be converted to an RGB image of (600,960,3). The converted RBG image can be resized to (60,96,3) pixels. The resized RBG image can be converted to an image cube of (60,96,31) pixels.

FIGS. 5G-5H illustrate a comparison of effects of pre-processing methods on the accuracy of the Hyperspec.py. FIG. 5G illustrates the effect of automatically cropping an input image to a 225×300 data set on a training accuracy 196a and a validation accuracy 196b of Hyperspec.py. FIG. 5H illustrates the effect of scaling the input image to a 225×300 data on a training accuracy 198a and a validation accuracy 198b of Hyperspec.py.

FIGS. 5G-5H also illustrates the relative significance of each channel image cube. For example, 31 different models can be created and trained. Each of the 31 models can be trained on one channel of the cube, therefore, each input to the model can have a size (60, 96) (i.e., only two dimensions). Each hyperspectral channel or band can be approximately 10 nm wide with channel 1 being about 400 nm to 410 nm in bandwidth and channel 10 being about 500 nm to 510 nm. This shows the relative importance of each wavelength band from 400 to 700 nm and indirectly yields information about the reflected chemical spectral peaks of the pill components with respect to how the CNN weights the importance of these peaks as a unique signature of the pill.

At block 174, training the CNN can be initiated. The training can involve 32 filters and an input kernel value of 3. At block 176, the CNN (e.g., Hyperspec.py) can be trained with ReLU activation and batch normalization. At block 178, blocks 174 and 176 can be repeated with 64 filters and the input kernel value being 3. At block 180, blocks 174 and 176 can be repeated with 128 filters and the input kernel value being 3. At block 182, the data can be flattened and a fully connected CNN layer can be set up with 1024 nodes and a dropout value of 0.5. At block 184, a fully connected layer with “X” nodes can be set up. “X” can refer to the total number of different pills to identify. For example, if only the pills shown in FIGS. 3C-3F are used, then X would be 4. At block 186, the accuracy probability can be determined. For example, Sofmax activation can be used and/or the accuracy probability can be determined after at least 80 epochs.

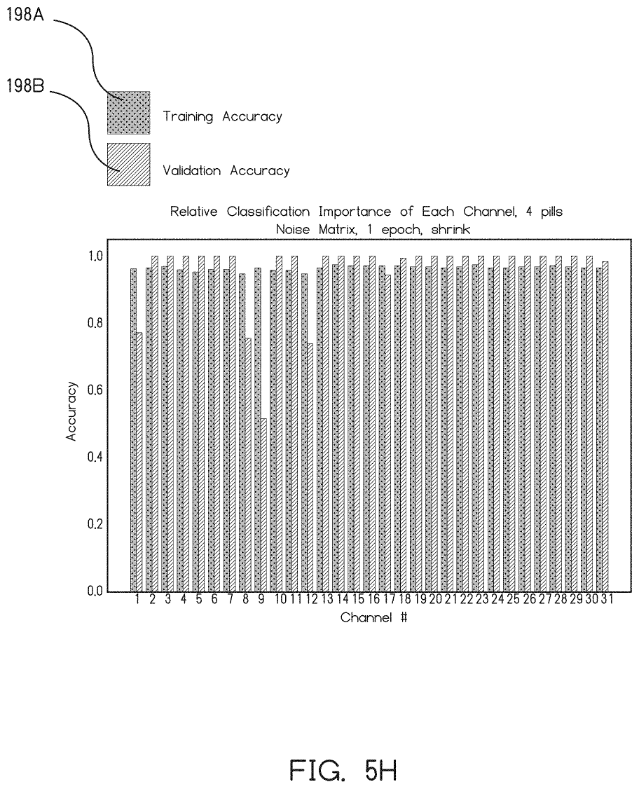

FIG. 6 is a flowchart illustrating an example algorithm 200 for training a CNN to identify a drug type of a drug based on a normal and/or hyperspectral image of the drug. At block 202, different images of different pills with different illumination can be captured, similar to block 152 in FIG. 5A. For example, a CMOS camera can be used with different LED illumination to capture both normal visible images and hyperspectral images. At block 204, labeled hyperspectral data cubes can be reconstructed using, for example, the pseudo-inverse method, similar to block 154 in FIG. 5A. At block 206, a HySp algorithm can be used to obtain data plots for a G-S plot from a Fourier-based phase analysis (e.g., pseudo-inverse method), similar to block 156 in FIG. 5A. At block 208, all labeled normal visible images can be placed into a folder. For example, normal images obtain via block 122 in FIG. 3A can be placed into a “PhoneCam” folder.

At block 210, the CNN can be quickly retrained with the G-S plot features and the normal image features as inputs into two different versions of “transfer_train.py.” At block 212, a hybrid “transfer_classify,py” can be run to compare identification results from hyperspectral images and normal visible images. The accuracy probability for a CNN trained with normal visible images and hyperspectral images of different drug types can be about 99%. Thus, the accuracy probability of a trained CNN can improve 10% by training the CNN with both normal visible images and hyperspectral images of different drug types.

### Methods of Use

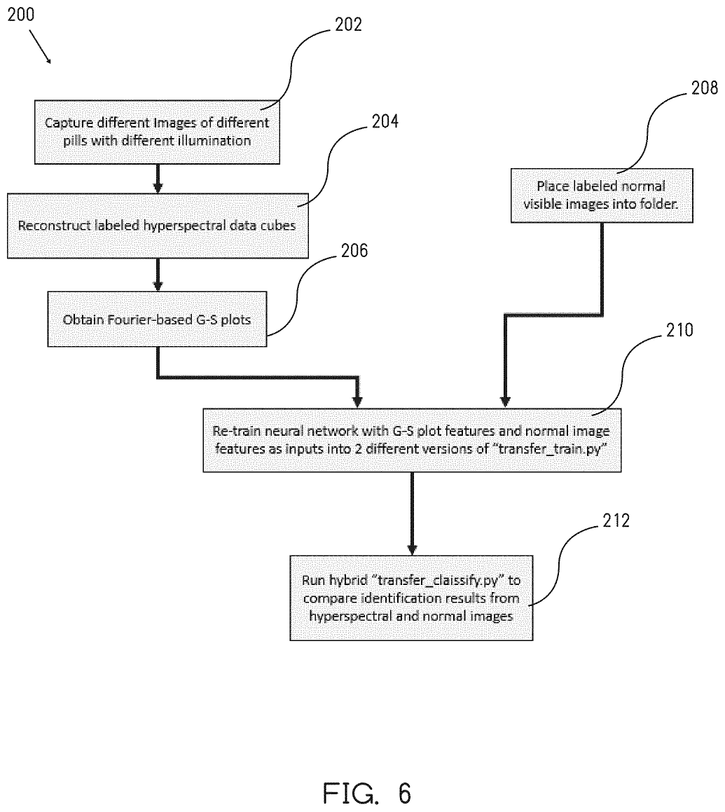

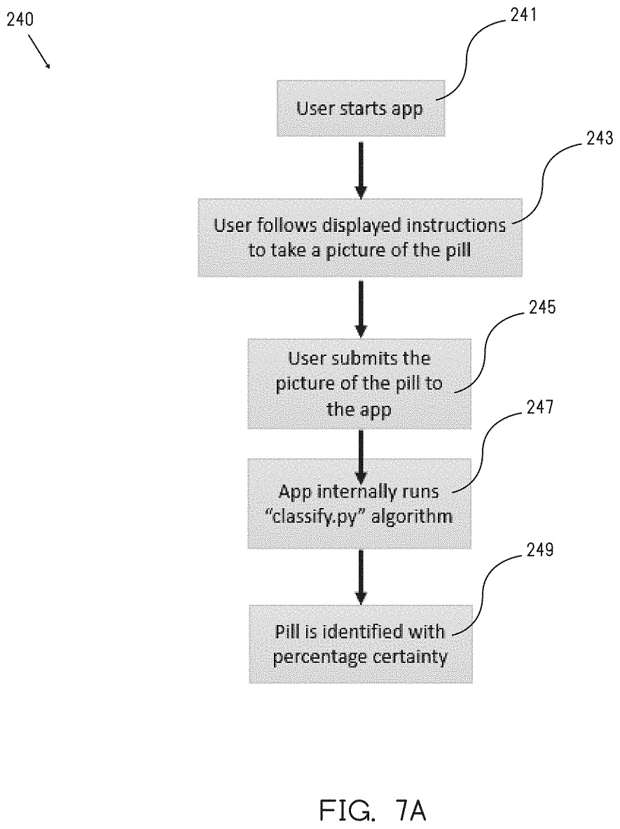

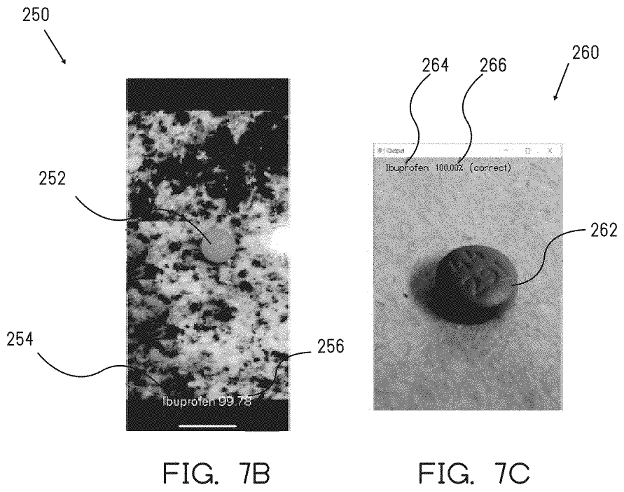

FIG. 7A is a flowchart that illustrates an example method of use 240. For example, a user can run a trained SmallerVGG on a user computing device, such as a smartphone, and/or a trained VGG-16 on another user computing device, such as a desktop computer. At block 241, the user can start the application. At block 243, the user can follow displayed instructions on their user computing device to take a picture of their pill. The user can use their user computing device or other camera to capture an image of their pill. At block 245, the user can submit the image of their pill into the application. At block 247, the application can internally run the “classify.py” algorithm. At block 249, the application can determine the pill type and the percent certainty that the determined pill type is correct. For example, FIGS. 7B and 7C illustrate sample results of the smallervggnet.py implemented on an iOS smartphone 250 and the VGG-16 implemented on a desktop computer 260. As shown FIG. 7B, the results of the trained smallervggnet.py can illustrate the sample test image depicting ibuprofen 252 with the predicted pill type 254 (e.g., ibuprofen) and the percentage certainty 256 (e.g., 99.78%). As shown in FIG. 7C, the results of the trained VGG-16 can illustrate the sample test image depicting ibuprofen 262 with the predicted pill type 264 (e.g., ibuprofen) and the percentage certainty 266 (e.g., 100%). In comparison, when identifying the same four types of pills based on the hyperspectral images of those pills, Hyperspec.py can more repeatedly produced 100% accurate identification.

### Additional Embodiments and Terminology

The components, steps, features, objects, benefits, and advantages that have been discussed are merely illustrative. None of them, nor the discussions relating to them, are intended to limit the scope of protection in any way. Numerous other examples are also contemplated. These include examples that have fewer, additional, and/or different components, steps, features, objects, benefits, and/or advantages. These also include examples in which the components and/or steps are arranged and/or ordered differently.

All of the features disclosed in this specification (including any accompanying exhibits, claims, abstract and drawings), and/or all of the steps of any method or process so disclosed, may be combined in any combination, except combinations where at least some of such features and/or steps are mutually exclusive. The disclosure is not restricted to the details of any foregoing examples. The disclosure extends to any novel one, or any novel combination, of the features disclosed in this specification (including any accompanying claims, abstract and drawings), or to any novel one, or any novel combination, of the steps of any method or process so disclosed.

Those skilled in the art will appreciate that in some examples, the actual steps taken in the processes illustrated or disclosed may differ from those shown in the figures. Depending on the example, certain of the steps described above may be removed, others may be added. For example, the actual steps or order of steps taken in the disclosed processes may differ from those shown in the figure. Depending on the example, certain of the steps described above may be removed, others may be added. For instance, the various components illustrated in the figures may be implemented as software or firmware on a processor, controller, ASIC, FPGA, or dedicated hardware. Hardware components, such as processors, ASICs, FPGAs, and the like, can include logic circuitry. Furthermore, the features and attributes of the specific examples disclosed above may be combined in different ways to form additional examples, all of which fall within the scope of the present disclosure.

Conditional language, such as “can,” “could,” “might,” or “may,” unless specifically stated otherwise, or otherwise understood within the context as used, is generally intended to convey that certain examples include, while other examples do not include, certain features, elements, or steps. Thus, such conditional language is not generally intended to imply that features, elements, or steps are in any way required for one or more examples or that one or more examples necessarily include logic for deciding, with or without user input or prompting, whether these features, elements, or steps are included or are to be performed in any particular example. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Likewise, the term “and/or” in reference to a list of two or more items, covers all of the following interpretations of the word: any one of the items in the list, all of the items in the list, and any combination of the items in the list. Further, the term “each,” as used herein, in addition to having its ordinary meaning, can mean any subset of a set of elements to which the term “each” is applied. Additionally, the words “herein,” “above,” “below,” and words of similar import, when used in this application, refer to this application as a whole and not to any particular portions of this application

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

Unless otherwise stated, all measurements, values, ratings, positions, magnitudes, sizes, and other specifications that are set forth in this disclosure are approximate, not exact. They are intended to have a reasonable range that is consistent with the functions to which they relate and with what is customary in the art to which they pertain.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain examples, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

All articles, patents, patent applications, and other publications that have been cited in this disclosure are incorporated herein by reference.

In this disclosure, the indefinite article “a” and phrases “one or more” and “at least one” are synonymous and mean “at least one”.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various examples to streamline the disclosure. This method of disclosure should not be interpreted as requiring claimed examples to require more features than are expressly recited in each claim. Rather, as the following claims reflect, inventive subject matter lies in less than all features of a single disclosed example. Thus, the following claims are hereby incorporated into the detailed description, with each claim standing on its own as separately claimed subject matter.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

What is claimed is:

1. A system for automated recognition of a drug, comprising:
a hyperspectral imaging system,
wherein the system for automated recognition of a drug is configured to automatically recognize a drug type of the drug based on an image of the drug.

2. The system for automated recognition of a drug of claim 1, wherein the system for automated recognition of a drug is configured to automatically recognize the drug type by using a trained neural network.

3. The system for automated recognition of a drug of claim 1 or claim 2, wherein the hyperspectral imaging system comprises a light source, a controller, a detector, and an information conveying system.

4. The system for automated recognition of a drug of any of the preceding claims, wherein the hyperspectral imaging system comprises one or more polarizers.

5. The system for automated recognition of a drug of claim 3 or claim 4, wherein the light source comprises an array of at least 2 light emitting diodes with more than 3 different spectral bands.

6. The system for automated recognition of a drug of any one of claims 3-5, wherein the light source comprises an array of 5 light emitting diodes with 6 spectral bands resulting in 31-band multispectral data.

7. The system for automated recognition of a drug of any one of claims 3-6, wherein the controller is configured to run a phasor analysis software to analyze hyperspectral data.

8. The system for automated recognition of a drug of any one of claims 3-7, wherein the detector comprises a camera.

9. The system for automated recognition of a drug of any one of claims 2-8, wherein the trained neural network is trained by using transfer learning.

10. The system for automated recognition of a drug of any one of claims 3-9, wherein the information conveying system comprises a display unit.

11. The system for automated recognition of a drug of any one of the preceding claims, wherein the hyperspectral imaging system is further configured to recognize the drug type by using one or more spectral bands that results in at least a 80% recognition accuracy for at least one spectral band.

12. The system for automated recognition of a drug of any one of the preceding claims, wherein the hyperspectral imaging system is calibrated by using a calibration standard.

13. The system for automated recognition of a drug of any one of the preceding claims, wherein the drug is an orally ingested medicine.

14. The system for automated recognition of a drug of any one of the preceding claims, wherein the system for automated recognition of the drug type is incorporated into a mobile device.

15. The system for automated recognition of a drug of any one of claims 2-14, wherein the trained neural network is configured to be trained and/or re-trained by incorporating a database into the system, wherein the database comprises information about commonly and/or uncommonly prescribed drugs.

16. The system for automated recognition of a drug of any one of claims 2-15, wherein the trained neural network comprises a convolutional neural network architecture.

17. The system for automated recognition of a drug of any one of the preceding claims, wherein the drug type includes a name of the drug.

18. The system for automated recognition of a drug of claim 2, wherein the image of the drug is an image generated by using the hyperspectral imaging system.

19. The system for automated recognition of a drug of claims 18, wherein the hyperspectral imaging system comprises a light source, a controller, a detector, an information conveying system, and at least one polarizer; wherein the light source comprises an array of at least 2 LEDs with more than 3 different spectral bands; and wherein the controller is configured to run a phasor analysis software to analyze hyperspectral data.

20. The system for automated recognition of a drug of claim 19, wherein the detector comprises a camera.

21. The system for automated recognition of a drug of claim 20, wherein the trained neural network is trained by using transfer learning.

22. The system for automated recognition of a drug of claim 21, wherein the hyperspectral imaging system is further configured to recognize the drug type by using one or more spectral bands that results in at least 80% recognition accuracy for at least one spectral band.

23. The system for automated recognition of a drug of any one of claim 22, wherein the light source comprises an array of 5 light emitting diodes.

24. The system for automated recognition of a drug of any one of claim 23, wherein the light source comprises an array of 5 light emitting diodes with 6 spectral bands resulting in 31-band multispectral data.

25. The system for automated recognition of a drug of claim 23, wherein the hyperspectral imaging system is calibrated by using a calibration standard.

26. A system for automating a recognition of a drug, the system comprising one or more hardware processors configured to:
process a plurality of images of the drug acquired from a hyperspectral imaging system; and
identify a drug type of the drug based on an application of a plurality of rules on the processed images.

27. The system for automating the recognition of the drug of claim 26, wherein processing the acquired plurality of images includes cropping each of the images.

28. The system for automating the recognition of the drug of claim 26, wherein processing the acquired plurality of images includes scaling down each of the images.

29. A method of training a neural network for identifying a drug, the method comprising:
collecting a plurality of images of a plurality of drug types from a database;
creating a training set of images comprising a first set of images of the plurality of images;
creating a validating set of images comprising a second set of images of the plurality of images;
applying one or more transformations to each of the images of the first set of images including cropping and/or scaling down to create a plurality of modified images;
training the neural network using the plurality of modified images; and
testing the trained neural network using the validating set of images.

30. The method of claim 29, wherein the plurality of images comprises normal visible images of the plurality of drug types.

31. The method of any one of claim 29 or claim 30, wherein the plurality of images comprises about 400 images of each of the plurality of drug types.

32. The method of any one of claims 29-31, wherein the plurality of images comprises different images including different backgrounds, different orientations of the drug, and/or different lighting.

33. The method of any one of claims 29-32, wherein the plurality of images comprise hyperspectral images of the plurality of drug types.

34. The method of claim 33, wherein the plurality of images comprise about six images of each of the plurality of drug types.

35. The method of any one of claims 29-34, further comprising, after collecting the plurality of images, injecting a Gaussian noise matrix into the plurality of images to increase a number of images.

36. The method of claim 34, wherein the plurality of images comprises different images including different orientations of the drug and/or different lighting.

37. The method of claim 29, wherein the neural network comprises a convolutional neural network.

38. A method of using a drug identification system configured to identity a drug type of a drug based on an image of the drug, the method comprising:
starting application on a user computing device;
capturing an image of the drug with a detector;
submitting the image of the drug into the application; and
receiving a determined drug type, wherein the determine drug type is displayed on the user computing device.

39. The method of claim 38, wherein the user computing device comprises a desktop computer, a laptop computer, or a smart phone.
